(19) United States
(12) Patent Application Publication
(10) Pub. No.: US 2025/0323418 A1
(43) Pub. Date: Oct. 16, 2025

(54) ANTENNA DEVICE

(71) Applicant: ASUSTeK COMPUTER INC., Taipei (TW)

(72) Inventors: Pin-Tang CHIU, Taipei (TW); Peng-Hao JUAN, Taipei (TW); Chung-Yen WU, Taipei (TW); Zhen-De JIANG, Taipei (TW); I-Chun LIAO, Taipei (TW)

(21) Appl. No.: 19/171,810

(22) Filed: Apr. 7, 2025

(30) Foreign Application Priority Data
Apr. 12, 2024 (TW) 113113880

(51) Int. Cl. H01Q 9/04; H01Q 1/38

(52) U.S. Cl. CPC H01Q 9/0414; H01Q 1/38; H01Q 9/045

(57) ABSTRACT

An antenna device is provided. The antenna device includes a carrier substrate. The carrier substrate has a first surface and a second surface that are opposite to each other, and a third surface adjacent to the first surface and the second surface. A first radiating portion, a second radiating portion, a signal source, a third radiating portion, and a fourth radiating portion are located on the first surface. A first shorting portion and a second shorting portion are located on the third surface. A ground portion is located on the second surface. The first radiating portion is connected to the second radiating portion. A gap is defined between the first radiating portion and the second radiating portion.

### CROSS-REFERENCE TO RELATED APPLICATION

This application claims the priority benefit of Taiwan Application Serial No. 113113880, filed on Apr. 12, 2024. The entirety of the above-mentioned patent application is hereby incorporated by reference herein and made a part of specification.

### BACKGROUND OF THE INVENTION

### Field of the Invention

The disclosure relates to a small-sized antenna device that meets a requirement of a metal environment.

### Description of the Related Art

With the advancement of science and technology, in addition to performance of products, consumers are also increasingly considering product appearance and texture when purchasing. Therefore, increasingly more products are made of metal as the first choice of a material for appearance of products, and various electronic products have become thinner and smaller. In this case, the antenna has to be designed in a metal environment whose height affects the antenna and suffers from compression of internal components, resulting in reduction of the antenna design space.

A common practice at present is to design a planar inverted F-shaped antenna (PIFA), a loop antenna, a coupled antenna, a monopole antenna, and the like. Such an antenna is placed in a space of a clearance region and as high as possible from a metal surface to prevent the metal from affecting the antenna characteristics. In addition, a patch antenna is also selected. However, generally speaking, such a patch antenna needs an extremely large design space and thickness to achieve good antenna characteristics. Alternatively, in a manner of forming a slot, although the antenna characteristics are maintained without occupying too much space. However, an obviously abrupt appearance is easily caused, which is in great conflict with the modern clean and neat product design. Therefore, the above common antenna forms are not in line with the design of current products, and it is difficult to meet the requirements of the existing antenna environment in a narrow antenna design space and an environment with no clearance region and surrounded by metal.

Therefore, how to design an antenna that simultaneously meets the requirements of miniaturization and application to the metal environment is the focus of current antenna design.

### BRIEF SUMMARY OF THE INVENTION

The disclosure provides an antenna device. The antenna device includes a carrier substrate, a first radiating portion, a second radiating portion, a signal source, a third radiating portion, a fourth radiating portion, a first shorting portion, a second shorting portion, and a ground portion. In the antenna device, the carrier substrate has a first surface and a second surface that are opposite to each other, and a third surface adjacent to the first surface and the second surface. The first radiating portion is located on the first surface away from the third surface. The first radiating portion has a first bent section which is bent at least once and extends in a direction towards the third surface. The second radiating portion is located on the first surface. One side of the second radiating portion is connected to the first bent section of the first radiating portion. An other side has a second bent section which is bent at least once and extends in a direction towards the third surface. A gap is defined between the first radiating portion and the second radiating portion. The signal source is located on the first surface and connected to the first radiating portion and the second radiating portion to transmit or receive a radio frequency signal. The third radiating portion is located on the first surface and located on an other side of the first radiating portion opposite to the second radiating portion. The fourth radiating portion is located on the first surface and adjacent to the third surface. One end of the fourth radiating portion is connected to the third radiating portion. An other end extends in a direction towards the second bent section. The first shorting portion is located on the third surface and connected to the third radiating portion. The second shorting portion is located on the third surface and connected to the second bent section of the second radiating portion. The ground portion is located on the second surface. The ground portion is connected to the first shorting portion and the second shorting portion.

Based on the above, the disclosure is an antenna device, which resonates the required antenna band at a special feeding position. The antenna device of the disclosure is directly constructed in a metal environment and maintains good antenna characteristics without the need for additional design of a clearance region. Therefore, an antenna is miniaturized on the premise of increasing an operable bandwidth of the antenna. Therefore, the disclosure is an antenna structure design that meets a metal environment and miniaturization, so as to effectively support a band of 2.4/5/6 GHz (2.4-2.48/5.15-7.125 GHz) and easily meet requirements of multi-frequency and broadband of the latest Wi-Fi 6E.

### BRIEF DESCRIPTION OF THE DRAWINGS

FIG. 1 is a schematic diagram of a three-dimensional structure of an antenna device according to an embodiment of the disclosure.

FIG. 2 is a schematic exploded view of an antenna device according to an embodiment of the disclosure.

FIG. 3 is a schematic structural diagram of an antenna device mounted to a system ground plane according to an embodiment of the disclosure.

FIG. 4 is a top view of an antenna device according to an embodiment of the disclosure.

FIG. 5 is a top view of an antenna device installed with a coaxial cable according to an embodiment of the disclosure.

FIG. 6 is a schematic diagram of S-parameter simulation of an antenna device according to an embodiment of the disclosure in each operating state.

### DETAILED DESCRIPTION OF THE EMBODIMENTS

Embodiments of the disclosure are described below with reference to related drawings. In addition, some elements or structures are omitted in drawings in the embodiments, to clearly show technical features of the disclosure. In the drawings, the same reference numerals indicate the same or similar elements or circuits. It is to be understood that although the terms “first”, “second”, and the like are used herein to describe various elements, components, regions, or functions, these elements, components, regions, and/or functions are not limited by these terms. These terms are only used to distinguish one element, component, region, or function from another element, component, region, or function.

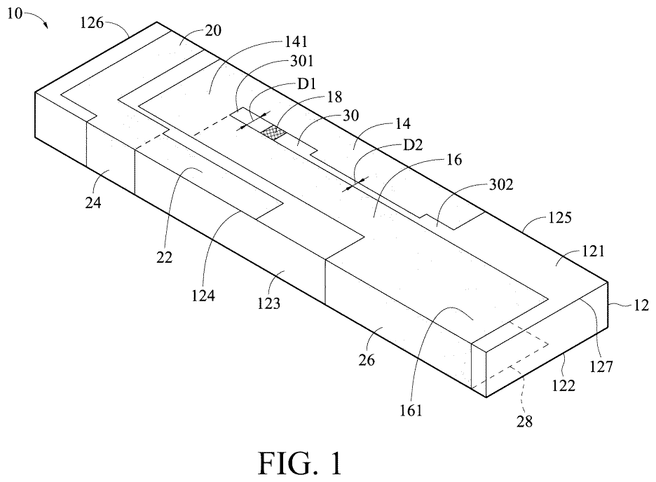

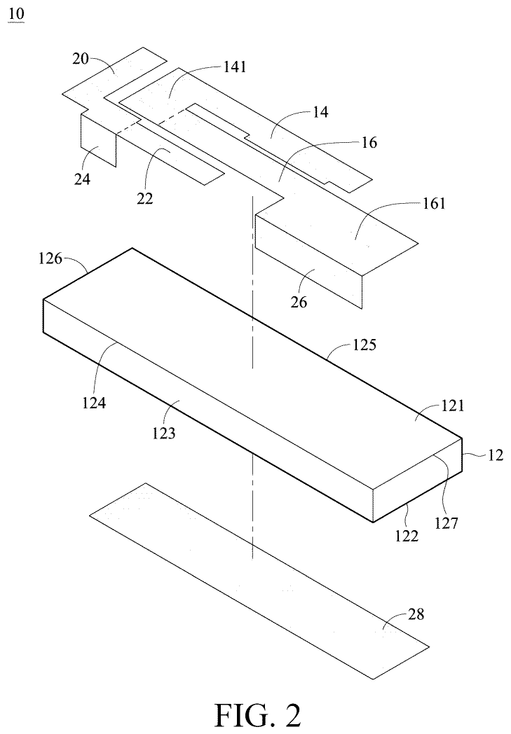

Refer to FIG. 1 and FIG. 2 together. An antenna device 10 includes a carrier substrate 12, a first radiating portion 14, a second radiating portion 16, a signal source 18, a third radiating portion 20, a fourth radiating portion 22, a first shorting portion 24, a second shorting portion 26, and a ground portion 28.

As shown in FIG. 1 and FIG. 2, in the antenna device 10, the carrier substrate 12 includes a first surface 121 and a second surface 122 that are opposite to each other, and a third surface 123 located between the first surface 121 and the second surface 122. The third surface 123 is simultaneously adjacent to the first surface 121 and the second surface 122. The first surface 121 has a first long side edge 124 and a second long side edge 125 that are opposite to each other, and a first short side edge 126 and a second short side edge 127 that are opposite to each other. The first short side edge 126 is connected to a same side of the first long side edge 124 and the second long side edge 125. The second short side edge 127 is connected to an other same side of the first long side edge 124 and the second long side edge 125. The first radiating portion 14 is located on the first surface 121 of the carrier substrate 12, and is located at a position away from the third surface 123, so that the first radiating portion 14 is arranged along the second long side edge 125. The first radiating portion 14 has a first bent section 141 which is bent at least once and extends in a direction towards the third surface 123 (a direction towards the first long side edge 124). The second radiating portion 16 is located on the first surface 121 of the carrier substrate 12. One side of the second radiating portion 16 is connected to the first bent section 141 of the first radiating portion 14. An other side thereof has a second bent section 161 which is bent at least once and extends in a direction towards the third surface 123 (the direction towards the first long side edge 124), so that the second bent section 161 extends to the first long side edge 124. The first radiating portion 14 and the second radiating portion 16 are jointly in the shape of a Chinese character C, so that a gap 30 is defined between the first radiating portion 14 and the second radiating portion 16. The signal source 18 is located on the first surface 121 and connected to the first radiating portion 14 and the second radiating portion 16 to transmit or receive a radio frequency signal. The gap 30 has a closed end 301 formed by the first radiating portion 14 and the second radiating portion 16 and a corresponding open end 302 thereof. The signal source 18 is located in the gap 30. A spacing of the gap 30 is divided into a first spacing D1 close to the closed end 301 and a second spacing D2 close to the open end 302. In this embodiment, the first spacing D1 is greater than the second spacing D2, but the disclosure is not limited thereto. The third radiating portion 20 is located on the first surface 121 of the carrier substrate 12, and is located on the other side of the first radiating portion 14 opposite to the second radiating portion 16, so that the third radiating portion 20 is close to the first short side edge 126. One end of the third radiating portion 20 extends to the second long side edge 125, and an other end thereof extends in the direction towards the third surface 123 (the direction towards the first long side edge 124). The fourth radiating portion 22 is located on the first surface 121 of the carrier substrate 12 and adjacent to the third surface 123. One end of the fourth radiating portion 22 is connected to the third radiating portion 20, and an other end thereof extends in a direction towards the second bent section 161 (a direction towards the second short side edge 127), so that the fourth radiating portion 22 is arranged along the first long side edge 124. The first shorting portion 24 is located on the third surface 123 of the carrier substrate 12 and connected to the third radiating portion 20. The second shorting portion 26 is located on the third surface 123 of the carrier substrate 12 and connected to the second bent section 161 of the second radiating portion 16. The ground portion 28 is located on the second surface 122 of the carrier substrate 12. The ground portion 28 is connected to the first shorting portion 24 and the second shorting portion 26, so that the third radiating portion 20 is electrically connected to the ground portion 28 through the first shorting portion 24, and the second radiating portion 16 is electrically connected to the ground portion 28 through the second shorting portion 26.

In an embodiment, the carrier substrate 12 is an antenna bracket or a dielectric substrate, but the disclosure is not limited thereto. The dielectric substrate is a flame retardant 4 (FR4) substrate, a printed circuit board (PCB), or a flexible printed circuit (FPC).

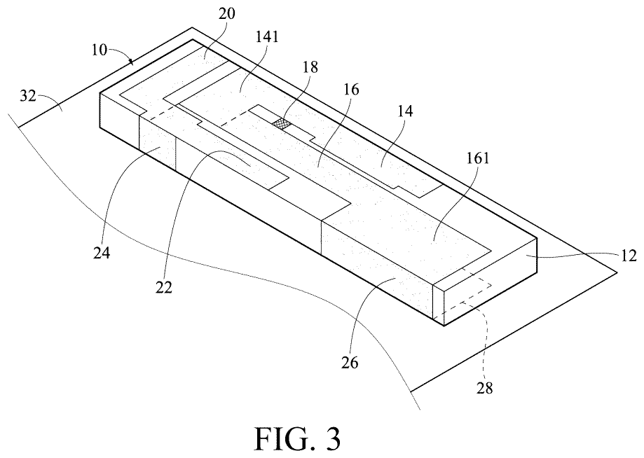

In an embodiment, the antenna device 10 is further mounted on a system ground plane 32 in an electronic device. As shown FIG. 3, the antenna device 10 is mounted on the system ground plane 32 in the electronic device through the second surface 122 of the carrier substrate 12, so that the ground portion 28 is electrically connected to the system ground plane 32. In an embodiment, the ground portion 28 is further electrically connected to the system ground plane 32 through a conductive medium (not shown in the figure). The conductive medium is any material with current conductivity, such as common conductive foam or conductive double-sided tape. A main function thereof is to increase a contact area to cause the conductive medium to be electrically connected more firmly.

In an embodiment, the foregoing electronic device is a tablet computer, a notebook computer, various wireless communication device, or the like, but the disclosure is not limited thereto. Any electronic device with a mobile communication function is encompassed in the disclosure. An example in which the electronic device is a notebook computer is used, so that the carrier substrate 12 of the antenna device 10 and components thereon are arranged on a metal casing of the electronic device. In this case, the system ground plane 32 is a metal plane at any appropriate position in the metal casing.

In an embodiment, as shown in FIG. 1 and FIG. 2, the first radiating portion 14 (including the first bent section 141), the second radiating portion 16 (including the second bent section 161), the third radiating portion 20, the fourth radiating portion 22, the first shorting portion 24, the second shorting portion 26, and the ground portion 28 are made of conductive metal materials, such as silver, copper, aluminum, iron, or an alloy thereof, but the disclosure is not limited thereto.

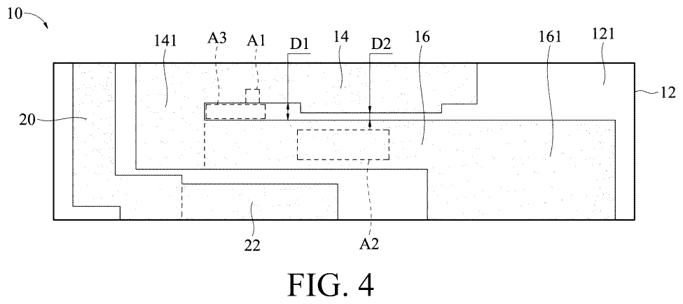

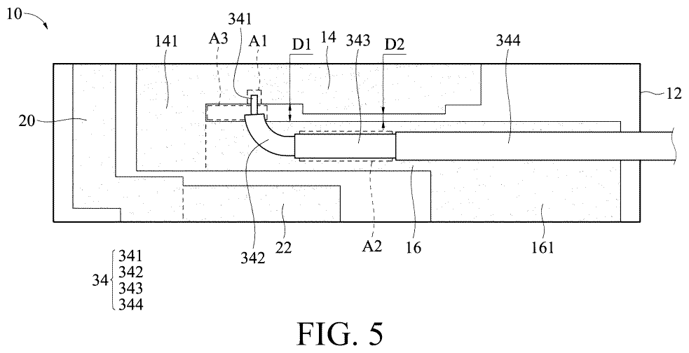

As shown in FIG. 1, FIG. 2, FIG. 4, and FIG. 5 together, the carrier substrate 12 of the disclosure has the first surface 121, the second surface 122, and the third surface 123. The first radiating portion 14, the second radiating portion 16, the third radiating portion 20, and the fourth radiating portion 22 are located on the first surface 121. The first shorting portion 24 on one side of the third surface 123 is connected to the ground portion 28 of the second surface 122. The second shorting portion 26 on an other side of the third surface 123 is also connected to the ground portion 28. Based on this, the first radiating portion 14 and the second radiating portion 16 in the antenna device 10 form a C-shaped structure. The signal source 18 is located at a position at a distance that is one third of a length of the first radiating portion 14 from an edge of the first radiating portion adjacent to the third radiating portion 20. Based on the signal source 18, the gap 30 between the first radiating portion 14 and the second radiating portion 16 forms two coupling spacing, that is, a first spacing D1 and a second spacing D2. In an embodiment, the first spacing D1 and the second spacing D2 are at least 0.2 mm and not more than 2 mm. As shown in FIG. 5, an example in which a signal feeding manner of the disclosure is generally a coaxial cable 34, but the disclosure is not limited thereto. The signal source 18 is connected to the first radiating portion 14 and the second radiating portion 16 through the coaxial cable 34. The coaxial cable 34 includes a core wire 341, a Teflon layer 342, a metal woven mesh 343, and an insulating layer 344 in sequence from inside to outside. The core wire 341 is electrically connected to a feeding region Al of the first radiating portion 14. The metal woven mesh 343 is electrically connected to a grounding region A2 of the second radiating portion 16, to form a small grounding circuit across the first spacing D1, that is, an adjustable matching region A3 shown in FIG. 5. A size of the adjustable matching region A3 and a magnitude of the first spacing D1 affect low-frequency and high-frequency impedance matching of the overall antenna device 10.

As shown in FIG. 1, FIG. 2, and FIG. 5 together, in the antenna device 10, the first radiating portion 14, the second radiating portion 16, the second shorting portion 26, and the ground portion 28 are configured to excite a first operation mode, which is a monopole antenna mode of 0.25 λ and has a resonance frequency of 2.45 GHz. In this way, a frequency and impedance matching of the first operation mode are adjusted through adjustment of a length and a width of each of the first radiating portion 14 and the second radiating portion 16. The signal source 18 is fed into the first radiating portion 14, so that a tail end of the first radiating portion 14 is configured to excite a second operation mode, whose resonance frequency is 5 GHz. In this way, a frequency and impedance matching of the second operation mode are adjusted through adjustment of the length and the width of the first radiating portion 14. Based on this, through adjustment of a length ratio of the first radiating portion 14 and the second radiating portion 16, a ratio of a high frequency to a low frequency is effectively controlled, and an antenna size is also reduced. In addition, impedance matching of the high frequency and the low frequency is also fine-tuned through adjustment of the foregoing second spacing D2. In addition, to meet an operating band of Wi-Fi 6E, a third radiating portion 20 is added by extending the ground portion 28 upward through the first shorting portion 24, so that the ground portion 28, the first shorting portion 24, and the third radiating portion 20 are configured to excite a third operation mode, which is also a monopole antenna mode of 0.25 λ and has a resonance frequency of 7 GHz. Furthermore, to achieve a better impedance bandwidth, a fourth radiating portion 22 is added at a junction of the third radiating portion 20 and the first shorting portion 24, which is kept parallel to the second radiating portion 16 and extends in a direction towards the second shorting portion 26 (a direction towards the second short side edge 127), so as to adjust impedance matching of a mode in a range of 5 GHz to 7 GHz through a path size of the fourth radiating portion 22. Therefore, based on the first operation mode, the second operation mode, and the third operation mode above, an operating bandwidth of the antenna device 10 of the disclosure meets a three-band operating band range of Wi-Fi 6E (2.4/5/6 GHZ, 2.4-2.48/5.15-7.125 GHz).

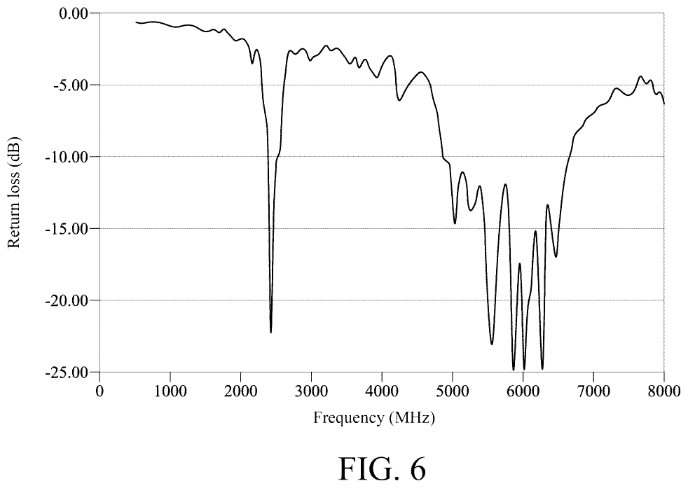

The antenna device 10 provided in the disclosure indeed has desirable antenna matching and efficiency. Refer to FIG. 1, FIG. 2, and FIG. 6 together. In the antenna device 10, a size of the antenna device 10 on the carrier substrate 12 is in a range of 5 mm*22 mm. In this way, the antenna device 10 performs simulation analysis of S-parameters (return loss) during transmission of a radio frequency signal. When the antenna device 10 is in a low-frequency operating band and a high-frequency operating band respectively, S-parameter simulation results thereof are shown in FIG. 6. It is learned from a curve shown in FIG. 6 that the return losses (S11) shown in the figure are both less than −5 dB (S11<−5 dB) in the low-frequency operating band and the high-frequency operating band. This proves that the antenna device has a desirable reflection coefficient in both the low-frequency operating band (the first operation mode) and the high-frequency operating band (the second operation mode and the third operation mode), which meets the operating band of 2.4-2.48/5.15-7.125 GHz of the Wi-Fi 6E system.

Based on the above, the disclosure is an antenna device, which resonates the required antenna band at a special feeding position. The antenna device of the disclosure is directly constructed in a metal environment (the system ground plane) and maintains good antenna characteristics without the need for additional design of a clearance region. Therefore, an antenna is miniaturized on the premise of increasing an operable bandwidth of the antenna. Therefore, the disclosure is an antenna structure design that meets a metal environment and miniaturization, so as to effectively support a band of 2.4/5/6 GHz (2.4-2.48/5.15-7.125 GHZ) and easily meet requirements of multi-frequency and broadband of the latest Wi-Fi 6E.

The foregoing embodiments are merely for describing the technical ideas and the characteristics of the disclosure, which are intended to enable a person skilled in the art to understand and implement the content of the disclosure accordingly, and do not constitute a limitation on the patent scope of the disclosure. In other words, equivalent changes or modifications made to the spirit disclosed in the disclosure still fall within the scope of the patent application of the disclosure.

What is claimed is:

1. An antenna device, comprising:
a carrier substrate, having a first surface and a second surface that are opposite to each other, and a third surface adjacent to the first surface and the second surface;
a first radiating portion, located on the first surface away from the third surface, wherein the first radiating portion has a first bent section which is bent at least once and extends in a direction towards the third surface;
a second radiating portion, located on the first surface, wherein one side of the second radiating portion is connected to the first bent section of the first radiating portion, an other side has a second bent section which is bent at least once and extends in a direction towards the third surface, and a gap is defined between the first radiating portion and the second radiating portion;
a signal source, located on the first surface and connected to the first radiating portion and the second radiating portion to transmit or receive a radio frequency signal;
a third radiating portion, located on the first surface and located on an other side of the first radiating portion opposite to the second radiating portion;
a fourth radiating portion, located on the first surface and adjacent to the third surface, wherein one end of the fourth radiating portion is connected to the third radiating portion, and an other end extends in a direction towards the second bent section;
a first shorting portion, located on the third surface and connected to the third radiating portion;
a second shorting portion, located on the third surface and connected to the second bent section of the second radiating portion; and
a ground portion, located on the second surface, wherein the ground portion is connected to the first shorting portion and the second shorting portion.

2. The antenna device according to claim 1, wherein the gap has a closed end formed by the first radiating portion and the second radiating portion and a corresponding open end thereof, the signal source is located in the gap, and a spacing of the gap is divided into a first spacing close to the closed end and a second spacing close to the open end.

3. The antenna device according to claim 2, wherein the signal source is located at a position at a distance that is one third of a length of the first radiating portion from an edge of the first radiating portion adjacent to the third radiating portion.

4. The antenna device according to claim 1, mounted to a system ground plane in an electronic device through the second surface, so that the ground portion is electrically connected to the system ground plane.

5. The antenna device according to claim 4, wherein the ground portion is further electrically connected to the system ground plane through a conductive medium.

6. The antenna device according to claim 1, wherein the signal source is connected to the first radiating portion and the second radiating portion through a coaxial cable.

7. The antenna device according to claim 6, wherein the coaxial cable comprises a core wire, a Teflon layer, a woven mesh, and an insulating layer in sequence from inside to outside, the core wire is electrically connected to the first radiating portion, and the woven mesh is electrically connected to the second radiating portion.

8. The antenna device according to claim 1, wherein the first radiating portion, the second radiating portion, the second shorting portion, and the ground portion are configured to excite a first operation mode.

9. The antenna device according to claim 1, wherein the signal source is fed into the first radiating portion, so that a tail end of the first radiating portion is configured to excite a second operation mode.

10. The antenna device according to claim 1, wherein the ground portion, the first shorting portion, and the third radiating portion are configured to excite a third operation mode.
